(19) United States
(12) Patent Application Publication
(10) Pub. No.: US 2004/0185235 A1
(43) Pub. Date: Sep. 23, 2004

(54) Shrinkable battery label

(76) Inventors: Philip Emery, Palmer, MA (US); David W. Constantine, Charlton, MA (US); Richard T. Skov, Spencer, MA (US)

Correspondence Address: Gauthier & Connors, LLP, Suite 3300, 225 Franklin Street, Boston, MA, 02110, US

(21) Appl. No.: 10/768,415

(22) Filed: Jan. 30, 2004

Related U.S. Application Data
(60) Provisional application No. 60/445,552, filed on Feb. 6, 2003.

(51) Int. Cl. B32B 3/00

(52) U.S. Cl. 428/204

(57) ABSTRACT

A thermally shrinkable pressure sensitive label has mutually perpendicular dimensions and comprises a composite of multiple layers. The shrink characteristics of the label are governed by a film component of the composite that is dimensionally stable at temperatures below an onset temperature, and that is thermally shrinkable when heated to temperatures at or above the onset temperature. Shrinkage caused by heating is greater in one as compared to the other of the mutually perpendicular dimensions.

### CROSS REFERENCE TO RELATED APPLICATIONS

This application claims priority from provisional patent application No. 60/445,552 filed Feb. 6, 2003.

### BACKGROUND DISCUSSION

1. Field of the Invention

This invention relates generally to pressure sensitive labels and is concerned in particular with shrinkable labels designed specifically for application to the cylindrical cases and end caps of dry cell batteries.

2. The Prior Art

With reference initially to FIG. 1, a typical dry cell battery is shown at 10 adjacent to a conventional label 12 prior to its application to the battery. The battery has a cylindrical case 14 with opposite end caps 16 perpendicular to the battery axis.

The label 12 is typically a multilayer composite coated on its underside 18 with a layer of pressure sensitive adhesive 20. The multilayer composite includes as a minimum a base film carrying the adhesive 18, and a protective transparent top film, with printed indicia interposed between the two films. The dimension “A” of the label is slightly longer than the height of the battery, and its dimension “B” is slightly greater than the battery circumference.

With reference additionally to FIGS. 2-4 it will be seen that the label 12 is applied by wrapping it around the battery case, with the side edges of the label being overlapped at a seam 22 running the height of the battery, and with end edges of the label overlapping the caps 16 of the battery as at 24.

During the application process, the conventional labels are typically subjected to elevated temperatures ranging from about 50 to 100° C. to effect a “primary” shrinkage in the “B” dimension as viewed in FIG. 1, the objective being to insure a tight wrinkle-free appearance.

The film components making up the label composite are conventionally selected from the group consisting of polyvinylchloride, polypropylene and polyester, with polyvinylchloride being most widely used as the base film responsible for the label stiffness and multidirectional shrink characteristics.

Although labels of the above-described type are in widespread use, their performance has been marred by several drawbacks. For example, during shipment, storage, and/or use, batteries are occasionally exposed to ambient temperatures in excess of 60° C., well above the temperatures that trigger shrinkage during label application. This can result in a further “secondary” shrinkage in both the “A” and “B” dimensions of the label. Secondary shrinkage in the “B” direction can pull the overlapped edges apart at the seam 22, causing the adhesive 18 to become exposed, and in extreme cases resulting in the metal case of the battery being exposed. When the adhesive is exposed during shipment and prior to packaging, the batteries can become stuck together, making it difficult to process the batteries through packaging equipment. Exposure of the battery case can result in premature battery discharge. This can occur during shipment or storage or while the batteries are in use.

Where batteries are tightly confined, for example in close fitting flashlight casings, any increase in the outer diameter of the batteries due to edge separation along the seam 22 can cause the batteries to become wedged in place, making replacement of the batteries difficult and in extreme cases, impossible without damaging the flashlights.

Unbalanced shrinkage between the base film and top film in the label laminate, or extreme growth of the base film relative to the top film in the “A” direction is particularly problematical in that it can cause a lifting of the end edges of the label from the end caps of the battery, a condition commonly referred to as “dog ears”. Although “dog ears” do not materially affect handling, performance or life of the battery, they are aesthetically objectionable, resulting in the batteries being rejected by the battery manufacturers.

Efforts at addressing these shrinkage-related problems have included the introduction of strategically placed slits in the base film in order to relieve thermally induced stresses, and the use of specially formulated adhesives with high performance properties including elevated shear strengths. None of these attempted solutions has proven to be satisfactory.

Also, some conventional battery label materials such as polyvinylchloride films, include compounds, e.g., oils, plasticizers, waxes, stabilizers, etc., that can bloom to the surface prior to final preparation of the battery label. This can create visual quality and functional problems during label preparation or subsequent application that cannot be addressed in subsequent processing, thereby creating excessive waste and resulting in increased costs.

### SUMMARY OF THE INVENTION

Viewed in its broadest sense, the present invention comprises a multilayer thermally shrinkable pressure sensitive label having mutually perpendicular “A” and “B” dimensions, with the shrink characteristics of the label being governed by those of a base film comprising one of the label layers. The base film is dimensionally stable at temperatures below an onset temperature, and is thermally shrinkable at or above that temperature, with shrinkage in one dimension, being greater than shrinkage in the other dimension. The base film has an onset shrinkage temperature of at least about 75° C., with shrinkage in the “B” dimension being greater than shrinkage in the “A” dimension. As herein employed, the term “onset shrinkage temperature” means the temperature at which a film undergoes shrinkage exceeding a threshold of about 2% in either the “A” or “B” dimensions while in an unrestrained state, i.e., not adhered to a substrate or to other components of a composite structure.

Preferably, the base film is a polystyrene film with thermally induced shrinkage in the “B” dimension being accompanied by a slight growth in the “A” dimension.

These and other features and attendant advantages of the present invention will now be described in greater detail with reference to the accompanying drawings, wherein:

### BRIEF DESCRIPTION OF THE DRAWINGS

FIG. 1 is a perspective view showing a pressure sensitive label prior to its application to a dry cell battery;

FIG. 2 is a view similar to FIG. 1 showing the label applied to the battery;

FIG. 3 is a sectional view through the seam defined by the overlapped side edges of the applied label;

FIG. 4 is a sectional view showing the end edges of the label overlapping the end cap of the battery;

FIG. 5 is a perspective partially broken away view of one embodiment of a label in accordance with the present invention;

FIG. 6 is a sectional view taken along line 6-6 of FIG. 5, with dimensions exaggerated for illustrative purposes; and

FIGS. 7-9 are sectional view depicting other embodiments of the present invention.

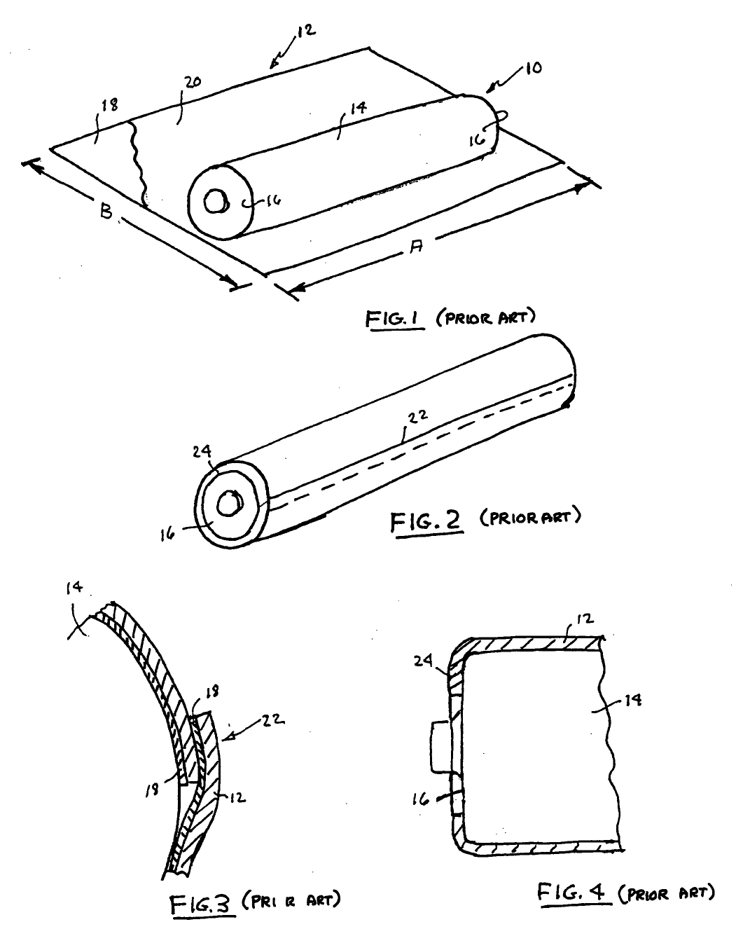

### DETAILED DESCRIPTION OF PREFERRED EMBODIMENT

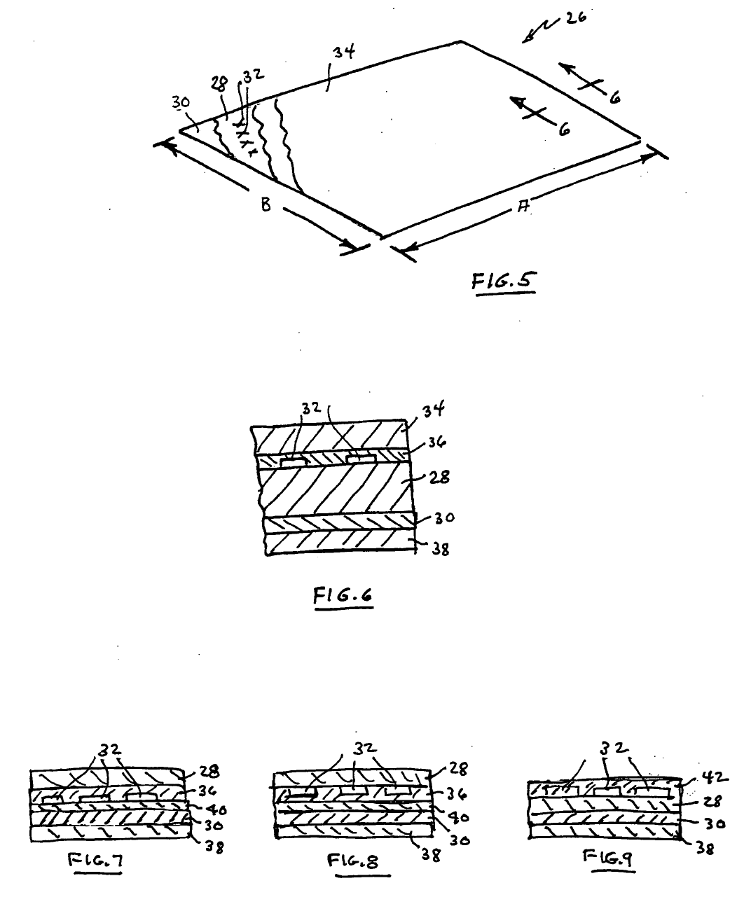

With reference additionally to FIGS. 5 and 6, a label in accordance with one embodiment of the present invention is generally designated at 26. The label 26 has “A” and “B” dimensions, and comprises a composite multilayer construction including a polymeric base film 28, a first pressure sensitive adhesive 30 for adhering the label structure to a battery substrate, indicia 32 applied to the top surface of the base film, and a transparent polymeric top film 34 overlying and adhered to the base film 28 by a transparent second adhesive 36. A liner 38 protects the adhesive 30 and is removed prior to application of the label to the battery substrate.

The base film 28 is preferably a polystyrene film, product designation No. 120 PFBX LMOPS supplied by Plastic Suppliers of Columbus, Ohio. Film 28 has an onset shrinkage temperature of about 75° C., with shrinkage occurring primarily in the “B” dimension. The thickness of film 28 can range from 0.01 to 0.05 mm, with thicknesses of between about 0.02 to 0.04 mm being preferable, with the most preferred thicknesses being about 0.03 mm.

In comparison to conventional polyvinylchloride films, polystyrene films have relatively low residual shrink forces after they undergo primary shrinkage during the label application process. Lower residual shrink forces in turn make it possible to select the base film adhesive 30 from a wider range of candidates, including lower performance and/or more economical adhesives.

The stiffness of film 28 in the “B” dimension (measured in accordance with TAPPI Paper Standard #T498 as modified in FLEXcon test method #203 test F17 for use with film substrates) is preferably between about 1 to 20 grams, with stiffnesses of 2 to 10 grams being most preferable.

Film 28 can be clear metalized or colored. The adhesive 30 is preferably an acrylic pressure sensitive adhesive, one example being product designation A-173, supplied by FLEXcon Company, Inc. of Spencer Mass. (“FLEXcon”).

The top film 34 may be selected from the group consisting of polyvinylchloride, polyester, polypropylene, or polystyrene and its thickness will preferably be less than that of the base film 28. The top film may either be unidirectionaly or bidirectionally shrinkable, and may either be extruded separately for subsequent application by the adhesive 36, or coated directly onto the film 28 and imprint 32. Preferably, however, the top film and base film are selected from the same polymer type in order to provide reasonably balanced shrink properties in the label composite and thereby allow for increased resistance to seam opening and “dog ears”.

The adhesive 36 may be of various types, including laminating, heat seal and pressure sensitive.

Although the polymeric base film 28 is preferably a polystyrene film as identified above, it is believed that other polymeric films, e.g., polypropylene, polyethylene and polyester can also be employed as base films, provided that they have equivalent performance characteristics including in particular high onset shrink temperatures and preferential shrinkage in their “B” dimensions.

In order to decrease the overall thickness of the label composite, and as shown in FIG. 7, an opacifying print receptive coating 40 may be applied to the adhesive 30. The indicia 32 is applied to the coating 40, and is then covered by a transparent base film 28 applied by means of an adhesive 36. The coating 40 may, for example, comprise a metal such as aluminum, or an inks such as Access White supplied by SICPA S.A. of Lausanne, Switzerland or various Rotomax colors available from Sun Chemical Corporation of Fort Lee, N.J.

The embodiment illustrated in FIG. 8 is similar to that illustrated in FIG. 7, except that here the indicia 32 is applied to the underside of the film 28 rather than to the opaque coating 40.

FIG. 9 discloses still another embodiment of the invention, where the indicia 32 is applied to the top surface of the bare film 28, the latter being metalized or pigmented to provide an opaque background. A protective coating 42 is applied over the indicia. The coating 42 may for example comprise a flexible varnish such as EC-0014 Aquagloss, Sericol UV383 or Sericol UV453, all available from Environmental Inks and Coatings Corporation of Morgantown, N.C.

In each of the embodiments shown in FIGS. 7-9, the adhesives may be of the same type as disclosed with reference to the embodiment of FIGS. 5 and 6. In all embodiments, the base film 28, which preferably comprises polystyrene, has a shrink onset temperature safely above that typically encountered by labeled batteries during packaging, storage and use, and that has a relatively low residual shrink force following primary shrinkage during label application. The shrink characteristics of the label are governed by those of the base film 28. Seam separation causing problematical exposure of adhesives and/or battery casings is thus avoided. Shrinkage of the film 28 during label application is unidirectional and in only the “B” dimension, and is preferably accompanied by a modest growth in the “A” dimension. Thus, “dog ear” problems are also avoided. Preferably, when employed, the top film 34 exhibits equal or lower shrink characteristics as compared to those of the base film, thus avoiding or at least minimizing internal stresses and resulting shrink related problems.

The polystyrene film 28 is also free of compounds that can bloom to the surface during preparation of the label composite.

We claim:

1. A thermally shrinkable pressure sensitive label having multiple layers and first and second dimensions measured in mutually perpendicular directions, said label comprising:
a polymeric film comprising one of said layers, said film being dimensionally stable at temperatures below an onset temperature and being thermally shrinkable when heated to temperatures at or above said onset temperature, with shrinkage caused by said heating being greater in one of said directions than in the other of said directions;
indicia interposed between adjacent layers of said label, said indicia being visible through a top surface layer of said label; and
a pressure sensitive adhesive defining the bottom surface of said label and comprising another of said layers.

2. The label of claim 1 wherein said onset temperature is at least about 75° C.

3. The label of claim 1 wherein said film is polystyrene.

4. The label of claim 1 wherein said film is selected from the group consisting of polystyrene, polypropylene, polyethylene and polyester.

5. The label of claim 1 wherein the thickness of said film is between about 0.01 to 0.05 mm.

6. The label of claim 5 wherein the thickness of said film is between about 0.02 to 0.04 mm.

7. The label of claim 6 wherein the thickness of said film is about 0.03 mm.

8. The label as claimed in claim 1 wherein the stiffness of said film in one of said directions as measured in accordance with TAPPI Paper Standard #T498 as modified by FLEXcon test method #203 Test F17 is between about 1 to 20 grams.

9. The label as claimed in claim 8 wherein said stiffness is between about 2 to 10 grams.

10. The label of claim 1 wherein said indicia is printed on an upper surface of said film.

11. The label of claim 10 wherein said pressure sensitive adhesive is applied to a lower surface of said film.

12. The label of claims 10 or 11 wherein said indicia is covered by a transparent second film adhered to said indicia by a second layer of pressure sensitive adhesive.

13. The label of claim 12 wherein said second film is thermally shrinkable at temperatures above said onset temperature.

14. The label of claim 12 wherein said first mentioned film and said second film are formed from the same polymeric material.

15. The label of claim 12 wherein the thickness of said first mentioned film is greater than the thickness of said second film.

16. The label of claim 1 further comprising an opacifying layer adhered to the upper surface of said pressure sensitive adhesive, said film being adhered to said opaque layer by means of a transparent second pressure sensitive adhesive layer, with said indicia being interposed between said opaque layer and said film.

17. The label of claim 16 wherein said indicia is printed on a top surface of said opaque later.

18. The label of claim 16 wherein said indicia is printed on a bottom surface of said film.

19. The label according to any one of claims 16-18 wherein said film comprises the top layer of said label.

20. The label of claim 1 wherein said indicia is printed on a top surface of said film, and wherein said indicia is covered by a transparent protective coating comprising the top layer of said label.

21. A thermally shrinkable pressure sensitive label having mutually perpendicular dimensions and comprising a composite of multiple layers, the shrink characteristics of said label being governed by a film component of said composite, said film component being dimensionally stable at temperatures below an onset temperature, and being thermally shrinkable when heated to temperatures at or above said temperature, with shrinkage caused by said heating being greater in one of said dimensions than in the other of said dimensions.
